(19) United States
(12) Patent Application Publication
(10) Pub. No.: US 2017/0112324 A1
(43) Pub. Date: Apr. 27, 2017

(54) SYSTEMS FOR GRINDING AND DISPENSING

(71) Applicant: Alpaca LLC, Spokane, WA (US)

(72) Inventors: Chase Dieken Kaczmarek, Spokane, WA (US); Christopher Wagner, Spokane, WA (US)

(21) Appl. No.: 15/296,266

(22) Filed: Oct. 18, 2016

Related U.S. Application Data
(60) Provisional application No. 62/246,141, filed on Oct. 26, 2015.

(51) Int. Cl. A47J 42/34; A47J 42/40

(52) U.S. Cl. CPC A47J 42/34; A47J 42/40

(57) ABSTRACT

A grinder system facilitates transporting, dispensing, and storing ground herbs, spices, or tobacco after they have been ground.

### CROSS-REFERENCE TO RELATED APPLICATION

This application claims the benefit of U.S. Provisional Application No. 62/246,141, entitled “A herb, spice, or tobacco grinder and dispenser” (filed Oct. 26, 2015), the contents of which are incorporated by reference herein in their entirety.

### TECHNICAL FIELD

Embodiments described herein relate to spice mills or grinders having pulverizing beaters or rotary knives that are hand driven. More particularly, embodiments relate to a system having two magnetically- and mechanically-coupled components that releasably engage with one another and, when rotated relative to one another, simultaneously grind and dispense a material.

### BACKGROUND

In many cases, transporting, dispensing, and storing ground herbs, spices or tobacco after grinding is impracticable or would lead to degradation of the flavor or quality of those substances. Systems for grinding herbs, spices, or tobacco are therefore known that permit for grinding at the point of use. Such systems can vary in design, size, and mechanism for grinding, depending on the material being ground and the eventual use.

For example, a mortar-and-pestle system can be used to crush harder spices (such as cinnamon or cloves), or to create pastes or powders (such as matcha or sencha teas). For other substances, such as pepper, cutting or cracking the spice is preferable, and so a bladed system such as a pepper grinder can be used. For very soft herbs where larger pieces are desired, herb scissors or a kitchen knife can be used. Each of these conventional solutions are needed at or near the place that the spices will be eventually used, because the quality of these substances decreases with exposure to light, oxygen, or other ambient conditions, and that degradation begins or significantly accelerates at the time when grinding occurs.

Despite significant improvements in materials, designs of the most popular spice or herb grinders has been substantially unchanged for millennia. The mortar and pestle, for example, has been substantially unchanged since the domestication of cereal crops.

### SUMMARY

According to an embodiment, a grinding system includes an outer cap having a first plurality of blades extending in a first direction and an inner cap configured to engage with the outer cap in a closed position. The inner cap has a second plurality of blades extending opposite the first direction and configured to be proximate the first plurality of blades when the inner cap is in the closed position, and at least one aperture. The grinding system further includes a dome configured to couple to the inner cap and arranged such that the inner cap is positioned between the dome and the outer cap in the closed position.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is an exploded side view of a grinder according to an embodiment.

FIG. 2 is a cross-sectional view of the grinder of FIG. 1.

FIGS. 4-6 depict a grinder, according to an embodiment.

FIG. 7A is a top view of an outer cap according to an embodiment.

FIG. 7B is a perspective view of the outer cap of FIG. 7A.

FIG. 8 is a bottom view of an inner cap configured to engage with the outer cap shown in

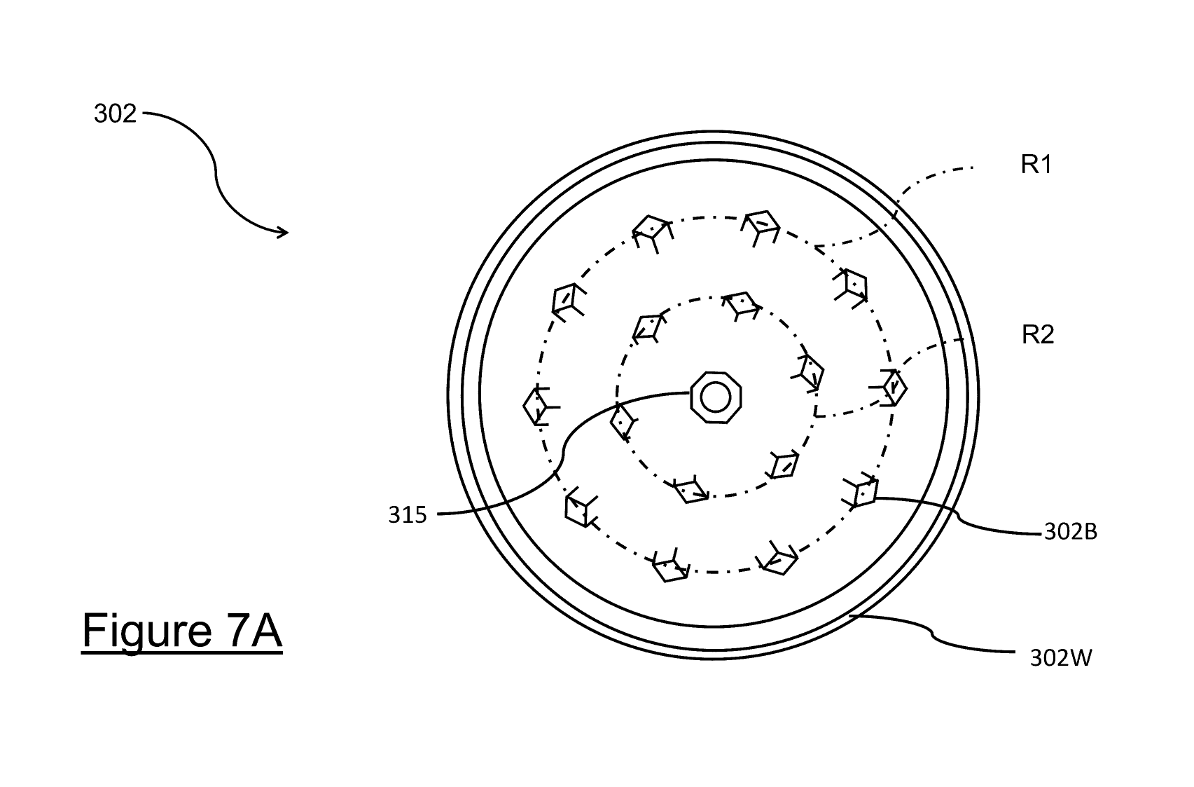

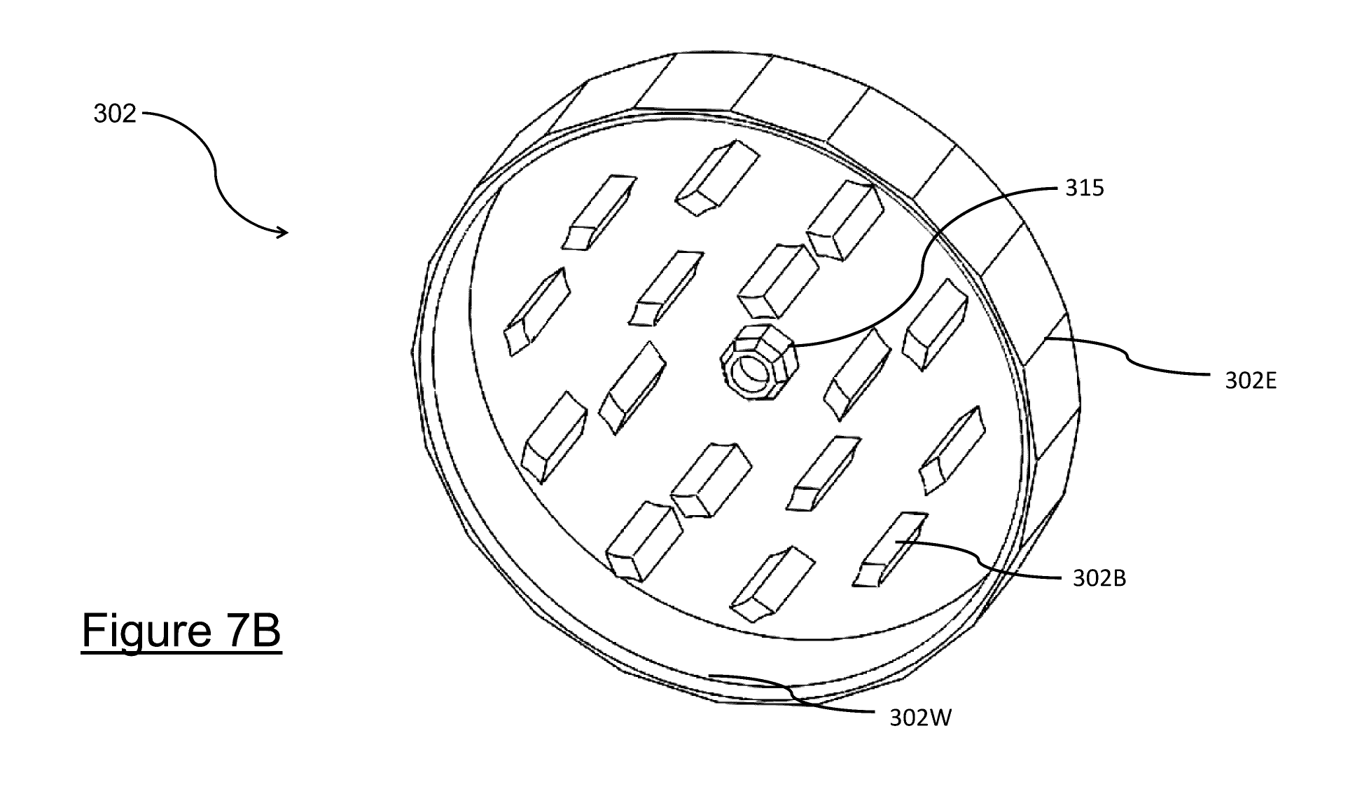

FIGS. 7A and 7B, according to an embodiment.

FIG. 9 is a top view of a blade according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

According to the embodiments described below, a grinder system incorporates features to promote even dispensing and storage, in addition to grinding. For example, embodiments can include an auger, tapered cone, dispense point, and cap, such that a user can easily grind, transport, dispense, and store their ground herbs, spices, and/or tobacco.

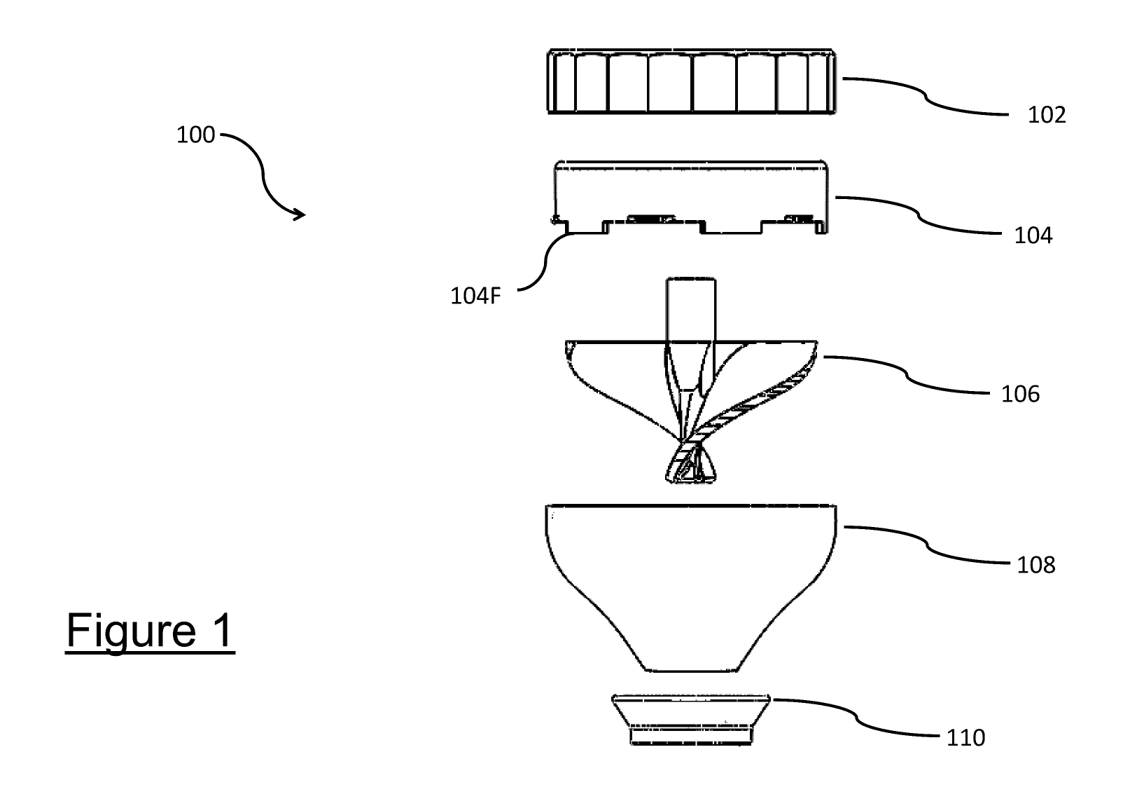

FIG. 1 is an exploded side view of one embodiment of such a system, grinder 100. Grinder 100 includes outer cap 102, inner cap 104, auger 106, dome 108, and stopper 110. Grinder 100 is a system for grinding and dispensing materials such as herbs and spices while also providing for storage or even distribution of those substances.

Outer cap 102, as shown in FIG. 1, is shaped to include detents or other features. A user can obtain better grip on outer cap 102 as a result of these features. Improved grip can be beneficial where a high amount of torque is needed to cut or grind a substance that is being ground in grinder 100. Outer gap 102 can also be made of some material that will facilitate grip. In the embodiment shown in FIG. 1, grinder 100 is designed for operation by hand. Therefore, outer cap 102 could be made of a material such as a metal, plastic, or composite that can be easily gripped. In some embodiments, the material that makes up outer cap 102 could be textured, or could have various other features that promote better grip and facilitate that application of torque on outer cap 102.

Inner cap 104 is not meant for gripping by a human hand. Rather, inner cap 104 is configured to rotate relative to outer cap 102 to cut or grind any substance positioned between them. As described in more detail below with respect to other figures, outer cap 102 and inner cap 104 each include blades or posts (not shown in this Figure) that shear materials positioned between them.

Outer cap 102 and inner cap 104 are configured to be coupled to one another via an interference fit, in the embodiment shown in FIG. 1. In alternative embodiments, outer cap 102 and inner cap 104 could be mechanically fixed to one another via some other fastening mechanism. For example, in alternative embodiments, outer cap 102 and inner cap 104 could be coupled to one another by an adhesive, brazing or soldering, or via fasteners such as screws. In embodiments, outer cap 102 and inner cap 104 engage with one another with a snap-type attachment, such that outer cap 102 and inner cap 104 are snapped together for semi-permanent engagement until a sufficient amount of force is applied to disengage them. In a snap-type fitting, outer cap 102 can be rotatable relative to inner cap 104 without significant mechanical impedance.

As outer cap 102 is rotated with respect to the remainder of grinder 100, the blades are moved relative to the posts to cause cutting, shearing, and/or grinding. Outer cap 102 and inner cap 104 include features that fix them to other components of grinder 100. In the embodiment shown in FIG. 1, outer cap 102 is configured to engage with auger 106, and inner cap 104 is configured to engage with dome 108.

The mechanisms for these mechanical engagements can vary between embodiments. In one embodiment, outer cap 102 can include a magnet that is configured to interact with a corresponding magnet in auger 106. In alternative embodiments, auger 106 could be configured to engage with outer cap 102 using a ball-and-socket snapping joint, with a spline, or with any other releasable fastener. The fastener is releasable so that auger 106 can be removed from outer cap 102 in some circumstances, such as to add more material to be ground or to clean out grinder 100. In alternative embodiments where cleaning or new material addition is possible via other mechanisms, it may not be necessary to affix outer cap 102 to auger 106 releasably. Rather, the attachment could be permanent or semi-permanent, such as by adhesive or brazing, for example.

Inner cap 104 is coupled to dome 108 via flange portions 104F that extend away from inner cap 104 in a direction opposite of outer cap 102. Flange portions 104F are configured to engage with features of an adjacent component, dome 108, in the embodiment shown in FIG. 1. In alternative embodiments, inner cap 104 and dome 108 could be configured to engage in some other way. Inner cap 104 and dome 108 could have complementary magnets to reversibly couple to one another, or interlocking teeth, could be threadably engaged, or could be coupled to one another via an interference fit (pop on, pop off) or some other mechanical or electromagnetic, reversible interaction.

Auger 106 and dome 108 have complementary shapes, in the embodiment shown in FIG. 1. These complementary shapes leave little or no clearance between auger 106 and dome 108. In use, an operator can hold dome 108 and twist outer cap 102 relative thereto. Because dome is coupled to inner cap 104 while auger 106 is coupled to outer cap 102, this twisting motion will cause two interactions. First, the blades or posts of outer cap 102 and inner cap 104 interact in a grinding, cutting, or shearing fashion. Second, auger 106 rotates relative to dome 108 to propel ground material away from inner cap 104 and towards stopper 110.

Stopper 110 is removably affixed to dome 108 at an aperture therein. In the embodiment shown in FIG. 1, stopper 110 is a compressible or elastomeric material, such that it can be snapped in or out of an aperture in dome 108. In alternative embodiments, stopper 110 could be affixed to dome 108 using a hinge or some other fastener. In this way, stopper 110 can seal the aperture in dome 108, such that dome 108 becomes a storage area for the ground material when stopper 110 is in a “closed” position. If, however, stopper 110 is removed or changed to an “open” position, then ground material can leave dome 110 through the aperture. Material leaving dome 108 can be propelled by auger 106 to a promote consistent rate of distribution of the ground material, in embodiments.

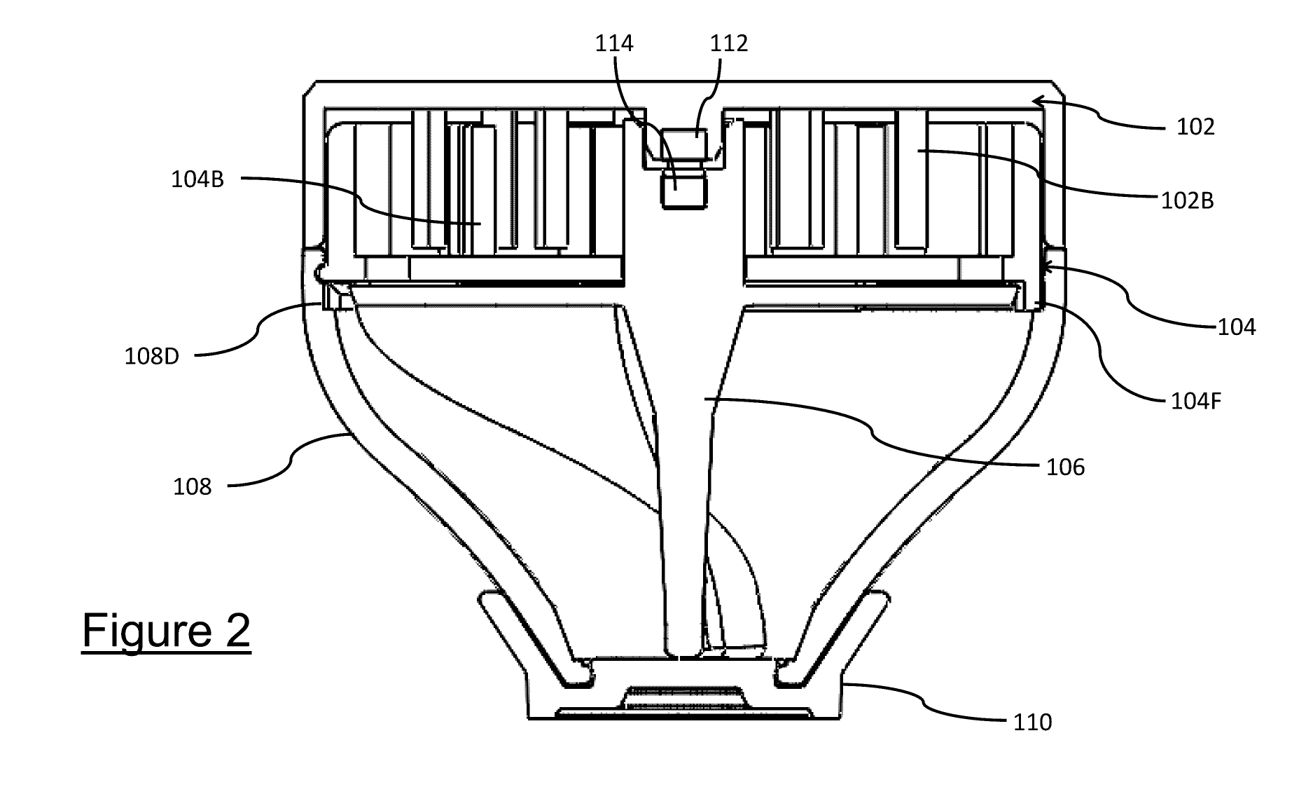

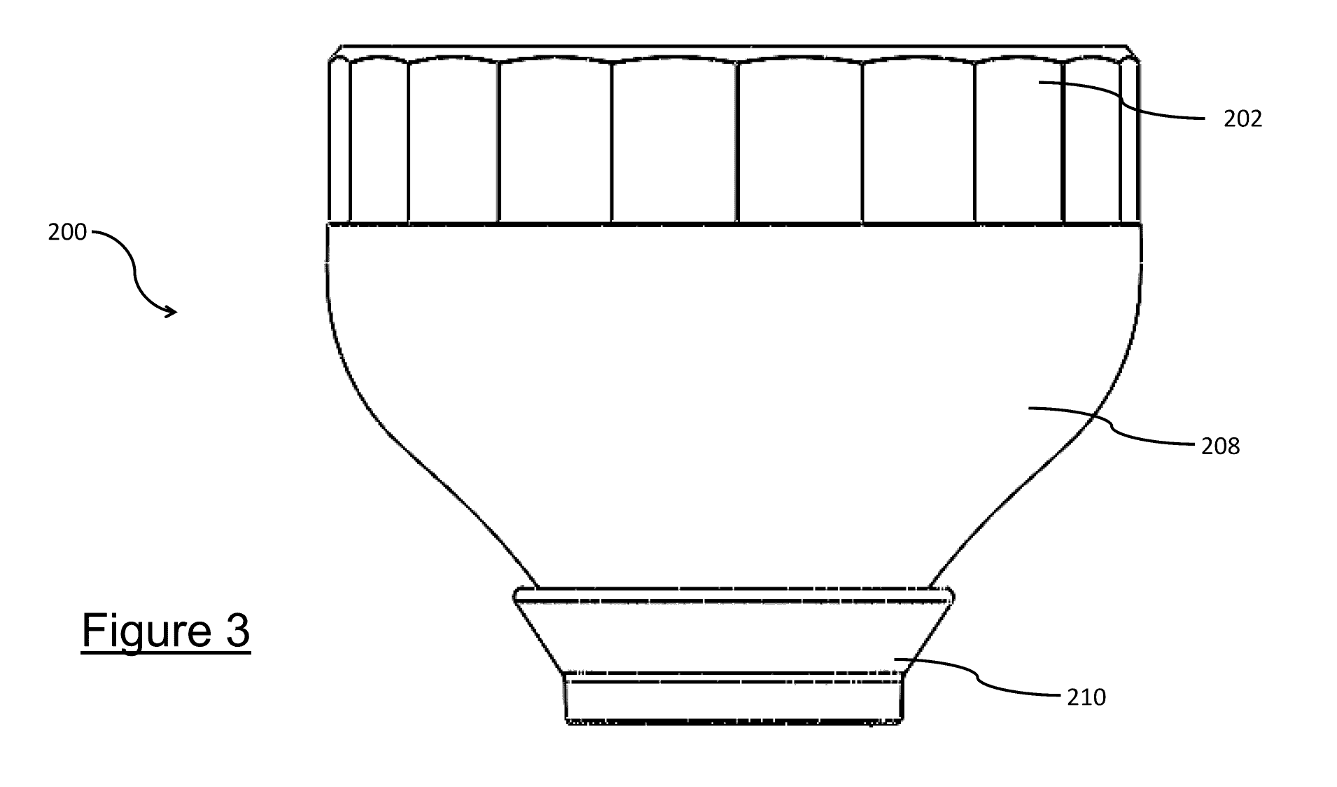

In this embodiment, as shown in more detail with respect to FIG. 2, stopper 110 is retained using a boss structure formed by stopper 110, which fits inside dome 108. In alternative embodiments, an equivalent to stopper 110 could be positioned on a boss arranged on the outside of dome 108 (not shown), for example. In still further embodiments, an equivalent to stopper 110 could be held to dome 108 using some other type of engagement structure, such as threading, or hinges, other types of interference fit, or adhesion, among others.

In alternative embodiments, various other features or combinations of features could be present. For example, in some embodiments, grinder 100 could include a reservoir of unground material, located above the outer and inner caps 102 and 104 in the reference frame of FIG. 1. Dome 108 could be shaped differently, as could auger 106 to match. For example, rather than having a frustoconical shape, dome 108 could be cylindrical, and auger 106 could be helical or some other type of screw or impeller that fits to that alternatively shaped dome 108. In the embodiment shown in FIGS. 1 and 2, dome 108 has a substantially constant thickness throughout, though in alternative embodiments dome 108 could have different thicknesses to facilitate manufacturing, for ergonomics or aesthetics, or based on expected workloads.

FIG. 2 is a cross-sectional view of the grinder 100 previously described with respect to FIG. 1, not in exploded view. Many of the same components previously described with respect to FIG. 1 are also shown in FIG. 2. In addition, FIG. 2 depicts outer cap blades 102B, and inner cap blades 104B. Outer cap blades 102B and inner cap blades 104B are arranged such that, when outer cap 102 is rotated relative to inner cap 104, their respective blades (102B, 104B) pass adjacent to one another, slicing or grinding whatever material is positioned therebetween.

FIG. 2 also shows dome 108, which is transparent in this particular embodiment, including detent 108D. Detent 108D is configured to engage with a flange 104F of the inner cap, to rotationally lock those two components together. Auger 106 is coupled to outer cap 102 via magnets 112 and 114. Outer cap 102 comprises first magnet 112, and auger 106 comprises second magnet 114. These two magnets hold auger 106 to outer cap 102. In alternative embodiments, as described above, other mechanisms for fastening these two components together could be used, such as a spline. In embodiments, to prevent relative rotation between outer cap 102 and auger 106, a locking mechanical engagement can be implemented.

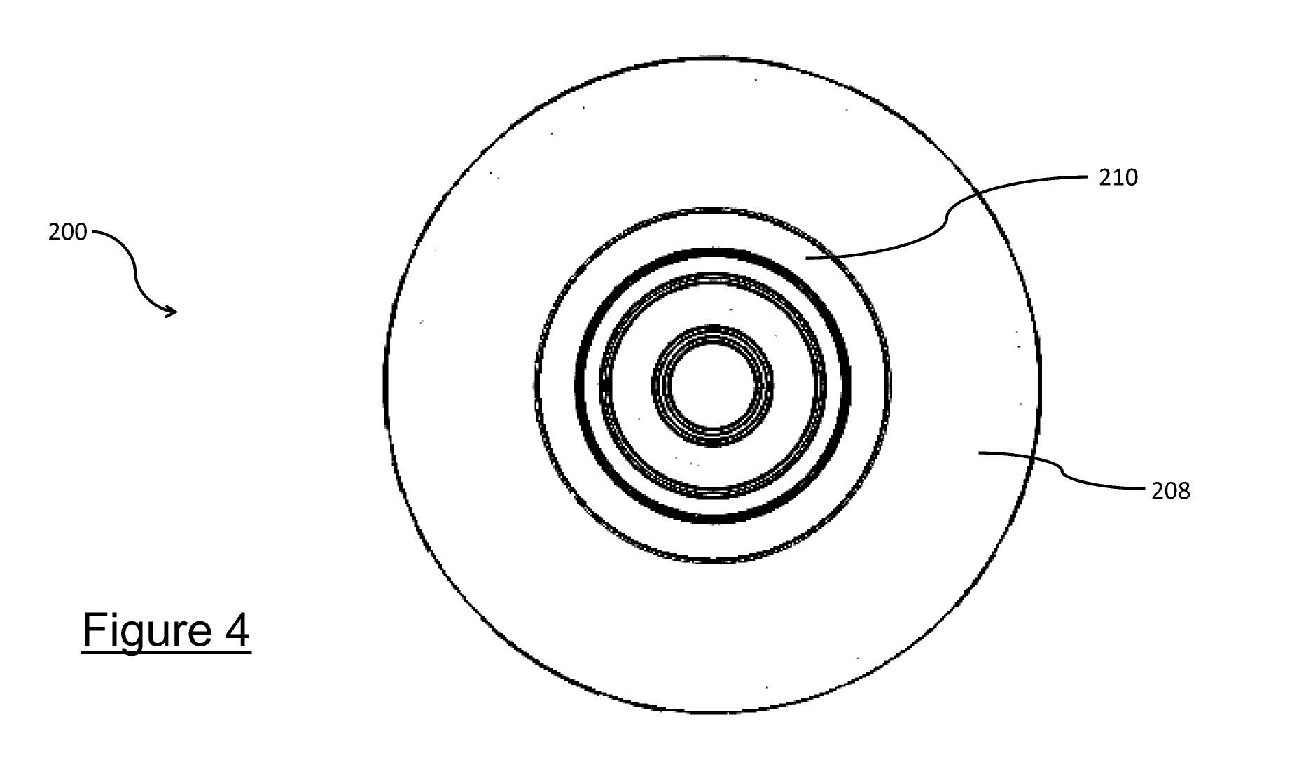

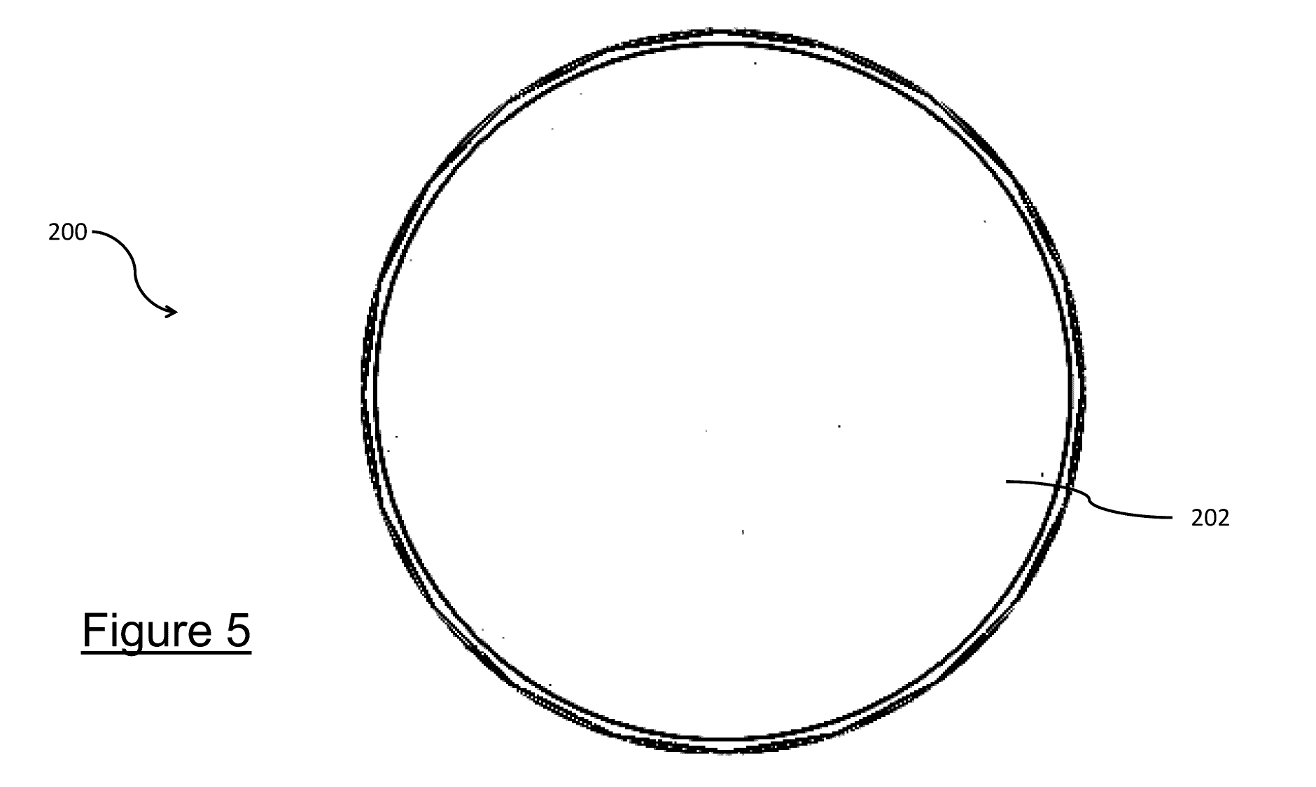

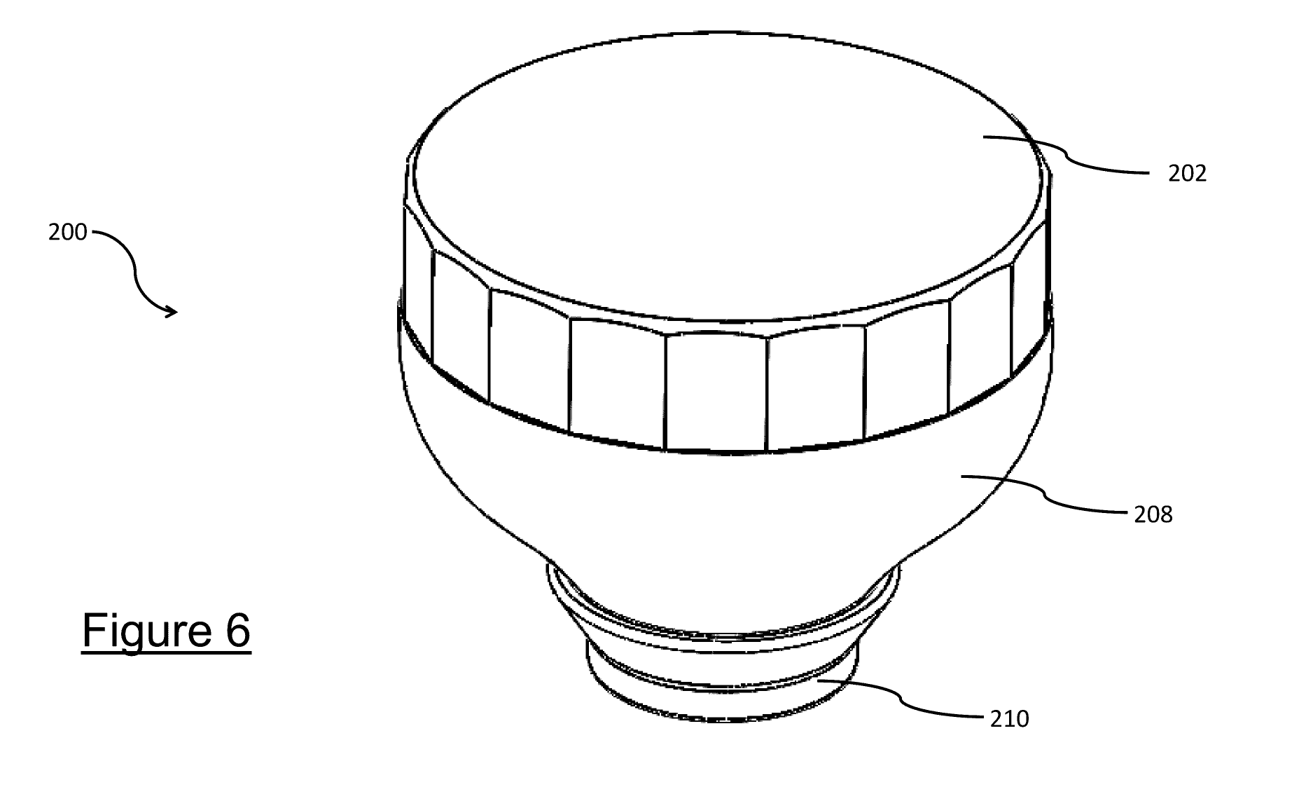

FIG. 3 is a side view of a grinder 200. Grinder 200 includes similar components to those described above with respect to the embodiment shown in FIGS. 1 and 2. Where like parts are used in grinder 200, those components have the same reference numerals as previously used to describe their counterparts in FIGS. 1 and 2, iterated by 100. As shown in FIG. 3, dome 208 is opaque, rather than transparent as shown with respect to FIG. 2. FIGS. 4-6 depict alternate views of grinder 200. In particular, FIG. 4 shows a top view of grinder 200; FIG. 5 shows a bottom view of grinder 200; and FIG. 6 shows a perspective view of grinder 200.

FIG. 7A is a top view of an outer cap 302, and FIG. 7B is a perspective view of the same, according to an embodiment. In the embodiment shown in FIGS. 7A and 7B, outer cap 302 is shown removed from the other components of a grinder (e.g., grinders 100 and 200 previously described with respect to FIGS. 1-6). Outer cap 302 includes wall 302W and blades 302B. Blades 302B are arranged in two sets, evenly distributed about inner ring R1 and outer ring R2. In alternative embodiments, blades 302B could be arranged in one, three, or any alternative number of rings.

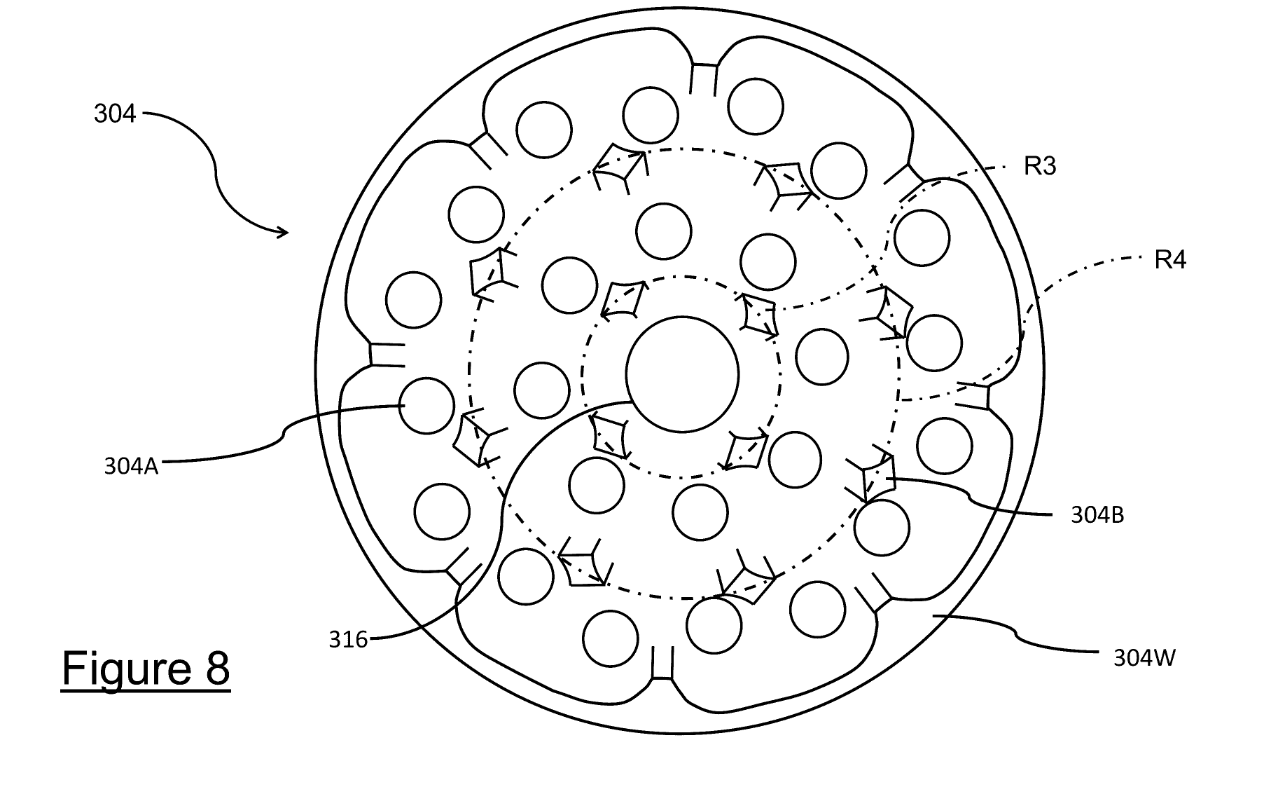

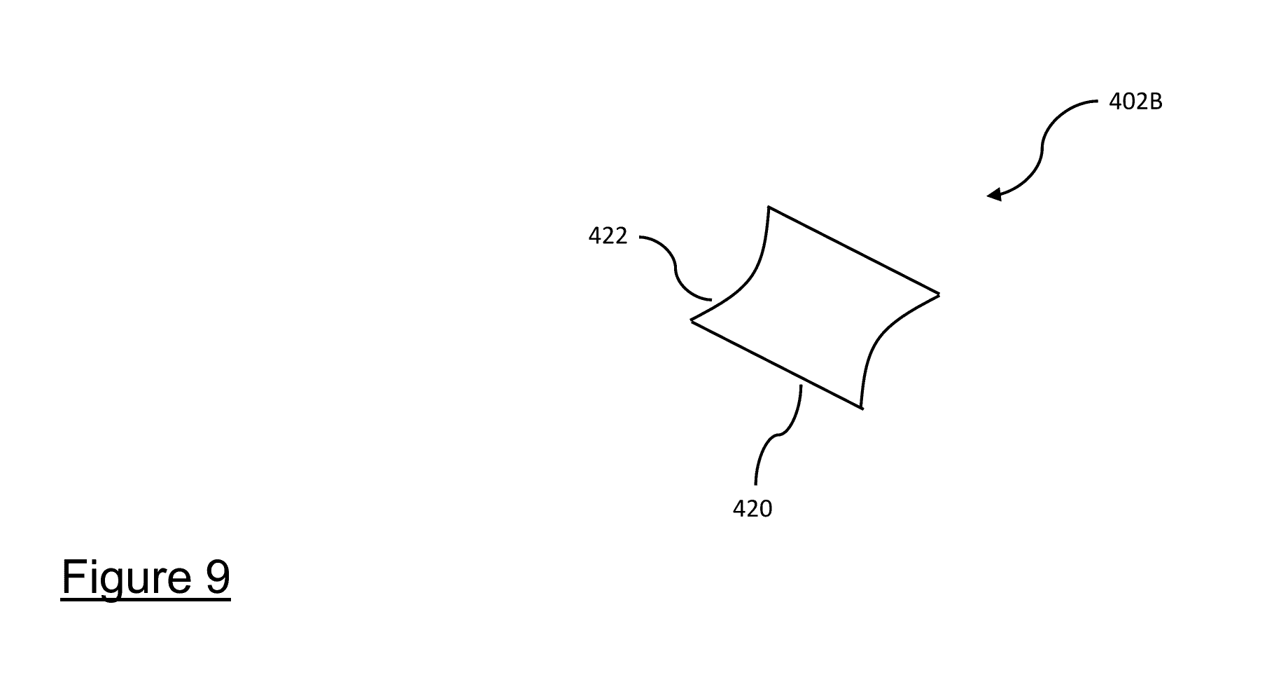

Blades 302B are prismatic posts extending parallel to wall 302W, in the embodiment shown in FIGS. 7A and 7B. The sharp edges of these prisms can cut, shear, grind, or crack material. In use, blades 302B engage with corresponding blades of a counterpart inner cap (see FIG. 8). In alternative embodiments, differently shaped blades 302B could be used. For example, where cracking or crushing is desired, a grinder could be used in which blades 302B are posts, rather than having cutting edges as shown on the substantially prismatic blades 302B of FIGS. 7A and 7B. The blades 302B of outer cap 302 need not be shaped in the same way as those of the inner cap (FIG. 8) in all embodiments.

In order to maintain sharpness, blades 302B are made of a material that will not easily dull, corrode, or become damaged through use. In one embodiment, blades 302B are machined from aluminum. In alternative embodiments, other metals or alloys, such as steel or titanium alloys, can be used. In still further embodiments, blades 302B can be made from a polymer or plastic.

FIGS. 7A and 7B also depicts hex engagement feature 315. Hex engagement feature 315 is configured to interact with the supporting post of an auger, screw, impeller, or other structure similar to auger 106 of FIGS. 1 and 2. In order to prevent rotation between that component and outer cap 302, the hex engagement feature 315 is provided to form a rotational lock. Other structures, such as splines, keys, or engagement features positioned radially outward from the center of outer cap 302 could be employed in other embodiments.

Furthermore, as shown in FIG. 7B in particular, engagement features 302E are positioned along the outer edge of wall 302W, to facilitate gripping of that structure in use.

FIG. 8 depicts an inner cap 304, according to an embodiment. Inner cap 304 is configured to engage with outer cap 302, previously described with respect to FIG. 7. As shown in FIG. 8, inner cap 304 includes many blades 304B, arranged about two rings R3 and R4. In operation, the blades 304B arranged about ring R3 can be rotated such that they pass close to the blades 302B arranged about ring R1 shown in FIG. 7. Likewise, the blades 304B arranged about ring R4 can be rotated such that they pass close to blades 302B arranged about ring R2 shown in FIG. 7.

Blades 304B shown in FIG. 8 are not shaped entirely as rectangular prisms. Rather, as depicted in the Figure, two surfaces of each side of the blades 304B includes some curvature. In embodiments, curvature can be added that promotes cutting of material passing between the blades of the various rings.

Inner cap 304 defines several apertures 304A. These apertures permit ground material to pass from the interstitial space between outer cap 302 and inner cap 304 out towards another area for storage or use (e.g., to dome 108 or 208 as previously described with respect to FIGS. 1-6). The apertures can vary in size or location, but often are sized to prevent unground material from passing into the adjacent structure for storage or use.

Inner cap 304 also defines a central aperture 316. Central aperture allows for a dispensing structure such as auger 106 to be coupled to outer cap 302, as shown for example with respect to FIG. 2. In embodiments without an auger or similar structure, central aperture 316 may not be needed, or could be sized differently such that it performs the same function as one of the various other apertures 304A.

An operator using a grinder or grinding system having outer cap 302 of FIG. 7 and inner cap 304 of FIG. 8 can put whole herbs, spices, or tobacco into the grinder chamber, for example. The operator can make a rotating motion to grinder the herbs, spices, or tobacco while holding the dome or cone (see FIGS. 1-6) stationary. Rotating the grinder or grinding system such that the outer cap (e.g., 102, 202, or 302) causes rotation of the auger (e.g., 106) relative to the inner cap (e.g., 104, 304). The ground herbs, spices, or tobacco created by interaction of the blades (e.g., 302B and 304B) fall from the interstitial space therebetween into the cone or dome and can be transported to the dispense point (e.g., aperture in dome 108 where stopper 110 is placed) by the auger. If the cap (e.g., 110) is in place, the ground herbs, spices, or tobacco will accumulate in the cone chamber, stored for later use. If the cap is removed, the ground herbs, spices, or tobacco will exit the cone at the dispense point at an even rate due to the auger.

The grinder parts can be machined out of metal using CNC or other machining systems, to result in a stronger finished product than other, additive manufacturing processes. The cone, auger, and cap can be made via injection molding, in embodiments. The male grinder piece is inserted into the female grinder piece making the grinder system or assembly. The auger can then be placed into the cone, coupled to the lower cap. The grinder assembly is placed into the auger-cone assembly and stays together via interference fit between the cone and the grinder assembly, in embodiments. The cap is placed on the dispense point of the cone and is kept in place by interference fit when desired.

If the operator does not want to use the storage option, the grinder system can be operated without the cap. If the operator does not want to use the auger to facilitate the even dispensing of grounds, the device can be operated without the auger installed. If the operator does not want to use the storage option and does not want to facilitate even dispensing of grounds using the auger, the device can be operated without the cap and cone installed.

FIG. 9 is a top view of a blade 402B according to an embodiment. As shown in FIGS. 7A, 7B, and 8, the overall blade shape is not strictly that of a rectangular prism. Rather, in embodiments, blade 402B includes straight edges 420 and curved edges 422. Curved edges 422 are concave, in the embodiment shown in FIG. 9.

Including curved edges 422, rather than just making blade 402B a rectangular prism, provides several advantages. First, curved edges 422 provide a larger cutting angle with another blade. By selectively setting the amount of convex curvature of blade 402B, the convex angle of curved edge 422 meets an adjacent blade near tangentially. This results in a very shallow cutting angle for material therebetween, and requires far less effort to operate. Reducing the force needed to operate the device can be beneficial for individuals with arthritis, for example, or individuals who have other force limiting impairments.

In the embodiment shown in FIG. 9, only two of the four edges are concave. In general, less than four concave edges is preferable, as the ground material can naturally follow the edge of the cutting surface and end up between the cutting teeth (e.g., blade 402B) during operation. By making only cutting edges of each blade (e.g., 402B) concave, material will not be trapped in concave section of non-cutting edges. In embodiments, a grinder has a linear edge which pushes the ground material towards the holes (described above) and minimizes jamming or hassles for the operator.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. §112(f) are not to be invoked unless the specific terms “means for” or “step for” are recited in a claim.

1. A grinding system comprising:
an outer cap having a first plurality of blades extending in a first direction;
an inner cap configured to engage with the outer cap in a closed position, the inner cap having:
a second plurality of blades extending opposite the first direction and configured to be proximate the first plurality of blades when the inner cap is in the closed position; and
at least one aperture; and
a dome configured to couple to the inner cap and arranged such that the inner cap is positioned between the dome and the outer cap in the closed position.

2. The grinding system of claim 1, wherein:
the first plurality of blades is arranged in a first ring; and
the second plurality of blades is arranged in a second ring having a different diameter than the first ring.

3. The grinding system of claim 2, wherein:
the first plurality of blades are arranged in a first set of rings; and
the second plurality of blades are arranged in a second set of rings, each of the second set of rings having a counterpart in the first set of rings, and each ring and its counterpart having different diameters.

4. The grinding system of claim 1, wherein the dome is cone-shaped.

5. The grinding system of claim 1, wherein each of the first plurality of blades and each of the second plurality of blades are shaped substantially as rectangular prisms having two concave edges and two linear edges.

6. The grinding system of claim 5, wherein at the two concave edges of the first plurality of blades have a radius of curvature configured to meet tangentially with the linear edges of the second plurality of blades.

7. The grinding system of claim 1, and further comprising an auger.

8. The grinding system of claim 7, wherein the auger is configured to match the shape of the dome.

9. The grinding system of claim 8, wherein the auger is mechanically coupled to the outer cap such that rotation of the outer cap with respect to the inner cap in the closed position causes co-rotation of the auger with respect to the inner cap.

10. The grinding system of claim 7, wherein the auger passes through a central aperture defined by the inner cap.

11. The grinding system of claim 1, wherein the dome defines an egress aperture.

12. The grinding system of claim 11, further comprising a stopper configured to block the egress aperture.

13. The grinding system of claim 1, wherein the outer cap comprises gripping features.

14. The grinding system of claim 1, wherein the inner cap and the outer cap are configured to engage by snapping together in the closed position such that:
a minimum predetermined force is necessary to disengage the inner cap from the outer cap; and
the inner cap is rotatable with respect to the outer cap in the closed position.

15. The grinding system of claim 14, wherein the outer cap and the inner cap are made of an aluminum alloy.

16. The grinding system of claim 1, wherein the dome is at least partially transparent.

17. The grinding system of claim 1, wherein:
the outer cap and the inner cap define an interstitial space therebetween in the closed position, the first plurality of blades and the second plurality of blades each projecting into the interstitial space; and
the at least one aperture of the inner cap comprises a plurality of apertures arranged to permit egress of material from the interstitial space to a region between the dome and the inner cap.

18. The grinding system of claim 1, wherein the dome and the inner cap are configured to couple to one another in the closed position.

19. The grinding system of claim 10, wherein the auger is coupled to the outer cap magnetically.

20. The grinding system of claim 12, wherein:
the stopper is made of a conformable material;
a boss is arranged circumscribing the egress aperture; and
the stopper snaps onto the boss to cover the egress aperture.
